(19) United States
(12) Patent Application Publication
(10) Pub. No.: US 2024/0253401 A1
(43) Pub. Date: Aug. 1, 2024

(54) PNEUMATIC TIRE

(71) Applicant: BRIDGESTONE CORPORATION, Tokyo (JP)

(72) Inventor: Norimasa YAMASHITA, Tokyo (JP)

(73) Assignee: BRIDGESTONE CORPORATION, Tokyo (JP)

(21) Appl. No.: 18/289,679

(22) PCT Filed: Jan. 13, 2022
(86) PCT No.: PCT/JP22/00934

§ 371 Date: Nov. 6, 2023

(30) Foreign Application Priority Data
May 18, 2021 (JP) 2021-084018

(51) Int. Cl. B60C 11/03; B60C 11/11

(52) U.S. Cl. CPC B60C 11/0302; B60C 11/11; B60C 2011/0341

(57) ABSTRACT

A pneumatic tire for use as an on-road driving wheel has the water discharge efficiency enhanced without impairing the traction performance. Also provided is a pneumatic tire (100) for use as a driving wheel, including a tread having a directional pattern containing a plurality of width-direction grooves (11) and (12). Assuming that a half-width region of the tread, as measured from the tire equator (CL) to the tread-to-ground contact end (TE) along the surface of the tire in a cross section of the tread portion (1) in the width direction of the tire, is bisected into two regions that are referred to as the tread center portion (Tc) and the tread shoulder portion (Ts) respectively in this order from the tire equator (CL), the plurality of width-direction grooves (11) and (12) extend across the tread center portion (Tc), and have a pattern convex in the rotational direction of the tire.

### TECHNICAL FIELD

The present invention relates to a pneumatic tire (hereinafter, also simply referred to as a “tire”), and relates more specifically to a pneumatic tire associated with the improvement of a tread pattern provided on the tread, and particularly to a pneumatic tire that is a driving wheel for a two-wheeled vehicle or a three-wheeled vehicle.

### BACKGROUND ART

Generally, a tread pattern composed of a plurality of groove portions and land portions is formed on the tread of a pneumatic tire to secure roadability in accordance with the usage. In particular, in the case of a tire to be used as a driving wheel of an off-road motorcycle about which running on an unpaved road surface is mainly assumed, a block pattern having directionality is widely used to obtain traction performance on a soft-soil road surface, in which directionality, the width-direction grooves arranged across the tire equator describe a pattern convex in the direction opposite to the rotational direction of the tire.

As an example of a conventional technology associated with such a block pattern, Patent Document 1 discloses a motorcycle tire the rotational direction of which is specified, and which has land portions sectioned by a plurality of width-direction grooves and a plurality of circumferential grooves in the central portion of the tread of the tire, in which at least one of the land portions has a pattern that satisfies predetermined conditions.

### RELATED ART DOCUMENT

### Patent Document

Patent Document 1: WO2020/031641

### SUMMARY OF THE INVENTION

### Problems to be Solved by the Invention

As described in Patent Document 1, it is common that, in the tread pattern of a driving wheel, the width-direction grooves arranged across the tire equator usually have a pattern convex in the direction opposite to the rotational direction of the tire.

On the other hand, in the case of a tire to be used as an on-road driving wheel about which running on a paved road surface is assumed, such a pattern having a high negative ratio as for off-road use does not make it possible to secure sufficient traction, and thus, it is necessary to decrease the ratio of grooves, and simultaneously secure the water discharge efficiency.

However, in the case of a tire to be used as an on-road driving wheel, simply decreasing the ratio of grooves, and providing width-direction grooves having a convex pattern and having a conventionally common directionality as described in Patent Document 1 does not make it possible to obtain water discharge efficiency and traction performance on a paved road surface. In particular, such a tire does not make it possible to sufficiently obtain water discharge efficiency that is not a problem with a tire for an off-road two-wheeled vehicle.

In view of this, an object of the present invention is to provide a technology in which improving the tread pattern of a pneumatic tire to be used as an on-road driving wheel enhances the water discharge efficiency without impairing the traction performance.

### Means for Solving the Problems

The present inventor has studied vigorously and has consequently come to complete the present invention through the discovery that allows the width-direction grooves arranged across the tire equator to have a pattern convex in the rotational direction of a tire, unlike a conventionally common tire, and makes it possible to obtain a tire that secures traction performance suitable for an on-road driving wheel and simultaneously to achieve enhanced water discharge efficiency.

That is, the present invention is a pneumatic tire for use as a driving wheel, including, on the tread of the tire, a directional pattern containing a plurality of width-direction grooves, and is characterized in that,
assuming that a half-width region of the tread, as measured from the tire equator to a tread-to-ground contact end along the surface of the tire in a cross section of the tread portion in the width direction of the tire, is bisected into two regions that are referred to as the tread center portion and the tread shoulder portion respectively in this order from the tire equator,
the plurality of width-direction grooves extend across the tread center portion, and have a pattern convex in the rotational direction of the tire.

In a tire according to the present invention, the ground contact surface preferably contains two to six of the width-direction grooves. In addition, in a tire according to the present invention, the average value Wg of the groove widths of the width-direction grooves, as measured on the tire equator, is suitably 4 mm or more and 13 mm or less. Furthermore, in a tire according to the present invention, the ratio r/Dw of the radius of curvature, r, to the maximum groove depth Dw of the width-direction groove is preferably 15% or more, wherein the radius of curvature is based on the boundary between the groove wall and the groove bottom on the leading side of the tire.

Furthermore, in a tire according to the present invention, a plurality of circumferential grooves are provided to allow the plurality of width-direction grooves to be in communication with each other on the tread. Assuming that, among the plurality of circumferential grooves provided between a pair of the width-direction grooves, the circumferential groove the closest to the tire equator is referred to as a circumferential center-portion groove, and another circumferential groove is referred to as a circumferential shoulder-portion groove, the ratio Ds/Dc of the maximum groove depth Ds of the circumferential shoulder-portion groove to the maximum groove depth De of the circumferential center-portion groove preferably satisfies 0.1 to 0.6.

In addition, in a tire according to the present invention, a plurality of blocks are defined on the tread. The ratio Lc/Wg is preferably 500% or less, assuming that Lc, as measured on the tire equator, is the average value of the lengths of center blocks located on the tire equator in the circumferential direction of the tire, the center blocks being among the plurality of blocks, and that Wg, as measured on the tire equator, is the average value of the groove widths of the width-direction grooves.

Furthermore, in a tire according to the present invention, the convex pattern of each of the plurality of width-direction grooves can be a pattern composed of one or two or more circular arcs.

Here, unless otherwise specified, the dimensions of a tire in the present invention have the values measured using a tire that is put on a rim prescribed in an industrial standard effective in an area where the tire is produced and used, and that is filled at an internal pressure prescribed in the industrial standard, and is left under no load. In addition, the industrial standard is, for example, JATMA (The Japan Automobile Tyre Manufacturers Association, Inc.) YEAR BOOK in Japan, ETRTO (European Tyre and Rim Technical Organisation) STANDARD MANUAL in Europe, or TRA (THE TIRE and RIM ASSOCIATION INC.) YEAR BOOK in the U.S.A.

### Effects of the Invention

According to the present invention, using the above-described constitution for a pneumatic tire to be used as an on-road driving wheel makes it possible to enhance the water discharge efficiency without impairing the traction performance.

### BRIEF DESCRIPTION OF THE DRAWINGS

FIG. 1 is a partial development depicting the tread of a two-wheeled vehicle tire that is an example of a pneumatic tire according to the present invention.

FIG. 2 is a cross-sectional view of the two-wheeled vehicle tire in the width direction, taken along a line Y-Y in FIG. 1.

FIG. 3 is a front view depicting the tread of the two-wheeled vehicle tire depicted in FIG. 1.

FIG. 4 is a cross-sectional view of the width-direction groove, taken along a line X1-X2 in FIG. 1.

### MODE FOR CARRYING OUT THE INVENTION

Embodiments of the present invention will now be described in detail with reference to the drawings.

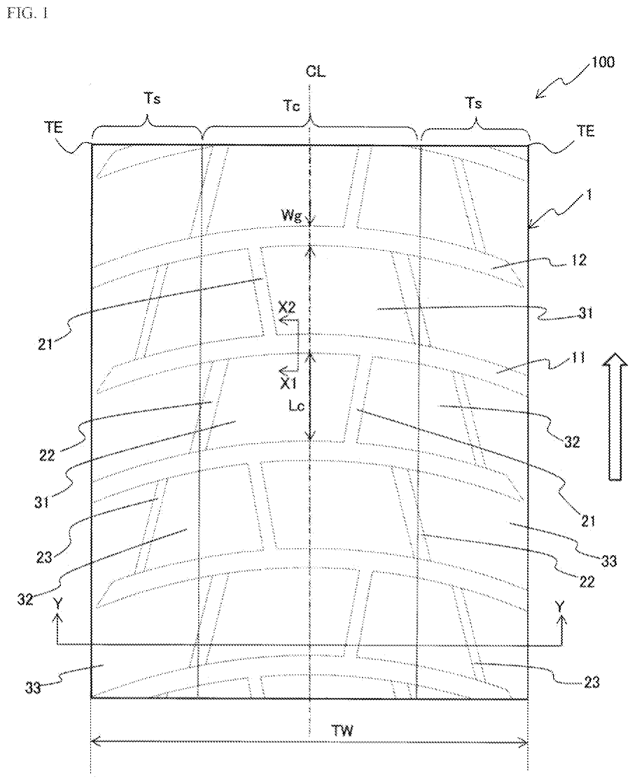

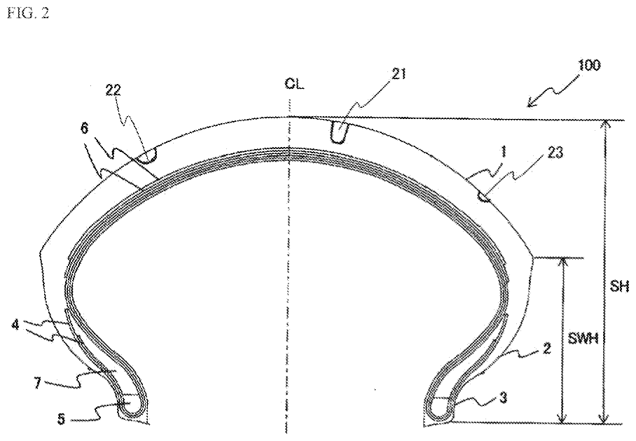

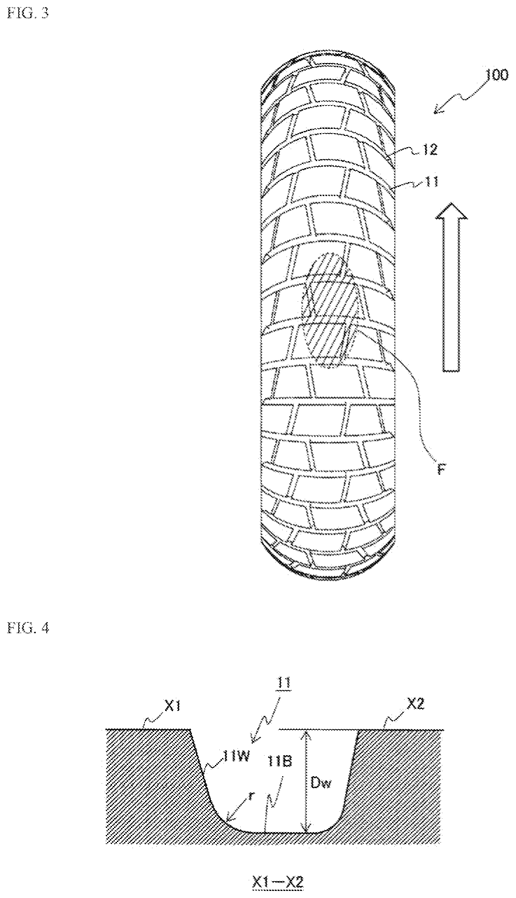

FIG. 1 depicts a partial development of the tread of a two-wheeled vehicle tire that is an example of a pneumatic tire according to the present invention. FIG. 2 depicts a cross-sectional view of the two-wheeled vehicle tire in the width direction, taken along a line Y-Y in FIG. 1. FIG. 3 depicts a front view of the tread of the two-wheeled vehicle tire depicted in FIG. 1. FIG. 4 depicts a cross-sectional view of the width-direction groove, taken along a line X1-X2 in FIG. 1. In addition, the arrows in FIG. 1 and FIG. 3 denote the rotational direction of the tire, and the hatched-line-shaded region surrounded by the dashed line in FIG. 3 denotes a ground contact surface.

As depicted, a pneumatic tire 100 according to the present invention includes: a tread portion 1 having a ground contact portion formed therein; a pair of side-wall portions 2 each extending inwardly in the radius direction of the tire from both ends of the tread portion; and bead portions 3. In addition, a pneumatic tire 100 according to the present invention is a tire for use as a driving wheel, including, on the tread of the tire, a directional pattern containing a plurality of width-direction grooves 11 and 12.

In the present invention, a half-width region of the tread, as measured from the tire equator CL to a tread-to-ground contact end TE along the surface of the tire in a cross section of the tread portion 1 in the width direction of the tire, is bisected into two regions that are referred to as the tread center portion Tc and the tread shoulder portion Ts respectively in this order from the tire equator CL. That is, assuming that the distance between the tread-to-ground contact ends TE, as measured across the surface of the tire, is a tread width TW, the tread center portion Tc is a region which corresponds to ½ of the tread width TW, and across which the tire equator CL is centered, and the tread shoulder portions Ts are a pair of regions each of which corresponds to ¼ of the tread width TW, and which are each located outside the tread center portion Tc in the width direction of the tire.

As depicted in FIG. 1, in a tire according to the present invention, the plurality of width-direction grooves 11 and 12 provided on the tread extend across the tread center portion Tc that is a region which corresponds to ½ of the tread width TW, and across which the tire equator CL is centered. In addition, the width-direction grooves have a pattern convex in the rotational direction of the tire on the surface of the tire.

According to the present invention, the width-direction grooves 11 and 12 extending across the tread center portion Tc have a pattern convex in the rotational direction of the tire, whereby it is made possible to obtain a tire having an excellent water discharge efficiency needed for on-road usage on a paved road surface, and particularly wet performance that can satisfy the water discharge efficiency of a vehicle running with the body tilted. On the other band, a tire according to the present invention also makes it possible to secure the traction performance needed for a driving wheel.

As above-described, traction performance on a soft-soil road surface is conventionally and commonly prioritized for an off-road tire as a driving wheel. Thus, the width-direction grooves arranged across the tire equator have a pattern convex in the direction opposite to the rotational direction of the tire, but the present inventor has made studies, and consequently discovered that giving a pattern convex in the direction opposite to this makes it possible to obtain a tire that achieves both water discharge efficiency and traction performance. Compared with this, a tire that is not driven does not require traction performance, and accordingly, it is common that the width-direction grooves arranged across the tire equator are arranged so as to have a pattern convex in the rotational direction of the tire, but the width-direction grooves having such directionality as in the present invention have hitherto not been adopted for a tire as a driving wheel in the art.

For example, in the case of a motorcycle tire as one example of a pneumatic tire according to the present invention, the front tire is not driven, and the rear tire is used as a driving wheel, and accordingly, the tire according to the present invention is preferably used as a rear tire.

Furthermore, the tread of the pneumatic tire 100 according to the present invention, as depicted, has what is called a block pattern in which a plurality of blocks 31 and 32 are defined by a plurality of width-direction grooves 11 and 12 and a plurality of circumferential grooves 21, 22, and 23. As above-described, however, such a block pattern is generally used for an off-road tire, and there are not many examples in which the block pattern is adopted for an on-road tire about which running on a paved road surface is assumed.

The arrangement conditions for the width-direction grooves 11 and 12 in the pneumatic tire 100 according to the present invention are not particularly limited as long as the conditions include extending across the tread center portion Tc, and having a pattern convex in the rotational direction of the tire.

For example, the pattern of each of the width-direction grooves 11 and 12 can be a convex composed of one or two or more circular arcs, and may have a straight-line portion. In a case where the pattern of each of the width-direction grooves 11 and 12 is composed of one circular arc, the radius of curvature, R. of each of the width-direction grooves 11 and 12 is preferably 80 mm or more and 400 mm or less, more preferably 120 mm or more and 370 mm or less, with respect to the tire equator CL. Bringing the radius of curvature, R, within the above-described ranges makes it possible to inhibit the stress concentration at the groove bottom at the top of the convex pattern, to thereby inhibit a crack or the like from being generated, and to secure durability, and also makes it possible to inhibit the generation of a difference in wear between the trailing side and the leading side, and to thereby inhibit uneven wear from being induced. In this regard, in the example depicted, the width-direction grooves 11 and 12 are formed in the shape of a circular arc having the center of curvature on the rear side in the rotational direction of the tire.

In addition, the length of each of the width-direction grooves 11 and 12 in the width direction of the tire needs to be set at ½ or more of the tread width TW. As depicted, the width-direction grooves 11 and 12 are provided so as to suitably extend across the tread center portion Tc up to the tread shoulder portion Ts, and be terminated at the tread-to-ground contact end TE or the vicinity thereof. Allowing the width-direction grooves 11 and 12 to extend up to the tread-to-ground contact end TE or the vicinity thereof at both sides of the tire in the width direction makes it possible that, in particular, a two-wheeled vehicle tire more favorably secures the water discharge efficiency of a vehicle running with the body tilted.

Furthermore, the groove width of each of the width-direction grooves 11 and 12 is preferably 4 mm or more and 13 mm or less, more preferably 5 mm or more and 11 mm or less, as the average value Wg of the groove width, as measured on the fire equator CL. Bringing the groove width of each of the width-direction grooves 11 and 12 within the above-described ranges makes it possible to more favorably achieve both water discharge efficiency and traction performance, and thus, is preferable. Here, the groove width in the present invention means the maximum width of the opening in a cross section perpendicular to the direction in which the groove extends. In this regard, the maximum groove depth of each of the width-direction grooves 11 and 12 can be 0.6 mm or more and 12 mm or less from the viewpoint of achieving both traction performance and water discharge efficiency.

Here, furthermore with reference to the groove width Wg of each of the width-direction grooves 11 and 12, the value of the ratio Lc/Wg is preferably 500% or less in percentages, assuming that Lc/Wg is the ratio of the average value Lc of lengths in the circumferential direction of the tire to the groove width Wg, wherein the lengths are the lengths of the center blocks 31 located on the tire equator CL among a plurality of blocks 31 and 32 arranged on the tread, and are measured along the tire equator CL. Allowing the ratio of the circumferential length of the center block 31 to the groove width Wg of each of the width-direction grooves 11 and 12 to satisfy the above-described range is preferable on account of the effect of enhancing on-road straight-line stability, in a case where a tire according to the present invention is a two-wheeled vehicle tire. The value of the ratio Lc/Wg is more preferably 250 to 460%.

Furthermore, as shown in FIG. 3, the width-direction grooves 11 and 12 are preferably arranged in such a manner that the number of the grooves contained in the tire-to-ground contact surface F is 2 to 6, particularly 3 to 5, thus making it possible to achieve a good balance between water discharge efficiency and rigidity. Here, the ground contact surface means a face where a tire is in contact with the ground when the tire is put on a rim, and filled at an internal pressure prescribed in the above-described industrial standard to be placed under a prescribed load. In particular, in a case where a tire according to the present invention is a two-wheeled vehicle tire or a three-wheeled vehicle tire, the ground contact surface means such a face during straight running.

Furthermore, as depicted in the cross-sectional view in FIG. 4, the value of the ratio t/Dw is preferably 15% or more in percentages in the present invention, assuming that r/Dw is the ratio of the radius of curvature, r, to the maximum groove depth Dw of the width-direction groove 11, wherein the radius of curvature is based on the boundary between the groove wall 11W and the groove bottom 11B on the leading side X1. Bringing the ratio of the radius of curvature, r, to the maximum groove depth Dw of the width-direction groove 11 within the above-described range makes it possible to inhibit stress concentration to the boundary, and to enhance the durability of the block, in which the stress is generated on the leading side X1 when traction occurs during running. The value of the ratio r/Dw is more preferably 20 to 300%. In this regard, such stress concentration as generated on the leading side X1 does not occur on the trailing side X2, which accordingly does not need such a condition as above-described. Here, the width-direction groove 11 has been described, and the width-direction groove 12 is the same. The value of the radius of curvature, r, on the leading side X1 can be specifically, for example, 3 mm or more and 8 mm or less.

Furthermore, in the present invention, a plurality of circumferential grooves 21 to 23 are provided to allow a plurality of width-direction grooves 11 and 12 to be in communication with each other on the tread, as shown in FIG. 1. In the present invention, water discharge efficiency is secured by virtue of the width-direction grooves 11 and 12, and thus, the arrangement conditions for the circumferential grooves 21 to 23 are not particularly limited.

In the present invention, assuming that, among the plurality of circumferential grooves provided between a pair of the width direction grooves 11 and 12, for example, three circumferential grooves 21 to 23 in the example depicted, the circumferential groove 21 the closest to the fire equator CL is referred to as a circumferential center-portion groove, and each of the other circumferential grooves 22 and 23 is referred to as a circumferential shoulder-portion groove, the ratio Ds/De of the maximum groove depth Ds of each of the circumferential shoulder-portion grooves 22 and 23 to the maximum groove depth Dc of the circumferential center-portion groove 21 suitably satisfies 0.1 to 0.6. That is, it is preferable that the groove depth of the circumferential center-portion groove 21 the closest to the tire equator CL is set the largest, and that the groove depth of each of the circumferential shoulder-portion grooves 22 and 23 other than the circumferential center-portion groove 21 is set small within the above-described range. This makes it possible to secure rigidity suitably, and enhance the steering stability. The value of the ratio Ds/De is more preferably 0.2 to 0.5.

Here, in a case where the plurality of circumferential shoulder-portion grooves 22 and 23 are provided as depicted, the above-described maximum groove depth Ds is defined as the average value of the maximum groove depths of the plurality of circumferential shoulder-portion grooves 22 and 23. Furthermore, as specific conditions for the circumferential shoulder-portion grooves 22 and 23, the groove width can suitably be 4 mm or more and 13 mm or less, and the maximum groove depth can suitably be 0.6 mm or more and 12 mm or Jess. Furthermore, the angle of each of the circumferential shoulder-portion grooves 22 and 23 to the circumferential direction of the tire can be −45° or more and 45° or less. In this regard, in the present invention, the number of circumferential shoulder-portion grooves is not particularly limited.

In the present invention, the arrangement conditions for the plurality of blocks 31 and 32 defined by the plurality of width-direction grooves 11 and 12 and the plurality of circumferential grooves 21 to 23 are also not particularly limited. For example, in the present invention, the length of each of the blocks 31 and 32 in the circumferential direction of the tire can be 26 mm or more and 41 mm or less. In addition, the length of each of the blocks 31 and 32 in the width direction of the tire can be 15 mm or more and 44 mm or less. Here, the length in the circumferential direction of the tire and the length in the width direction of the tire each means the maximum value in each block.

In addition, in the pattern depicted, shoulder land portions 33 sectioned by the width-direction grooves 11 and 12 and the circumferential grooves 22 and 23 are provided outside the blocks 31 and 32 in the width direction of the tire. In the present invention, the shape and the like of this shoulder land portion 33 are also not particularly limited.

In this regard, in the present invention, the pattern formed with the plurality of width-direction grooves 11 and 12 and the plurality of circumferential grooves 21 to 23 has a shape substantially symmetrical about the tire equator CL, and is arranged repeatedly in the circumferential direction of the tire with a shift corresponding to ½ of the arrangement pitch, as depicted. Here, the arrangement pitch of the pattern in the present invention means one repeating unit in the circumferential direction of the tire in a pattern formed with the grooves provided in the tire tread.

In the pneumatic tire 100 according to the present invention, the negative ratio is preferably less than 70%, more preferably in the range of from 10 to 60%, particularly preferably in the range of from 20 to 50%. Bringing the negative ratio within the above-described ranges makes it possible to secure the water discharge efficiency of the tread favorably, and simultaneously maintain the steering stability and the ride quality favorably. Here, the negative ratio is the ratio of the area of the grooves to the area of the surface of the tread assumed to have no groove, and means the ratio of the groove portion excluding sipes to the area of the tread.

In the pneumatic tire 100 according to the present invention, the tread pattern of the tread needs only to satisfy the above-described conditions. Other than this, the details of the structure of the tire, materials to be used, and the like are not particularly limited. For example, the tire can be constituted as below-described.

The backbone of the pneumatic tire 100 depicted is two carcass plies 4 extending in the form of a toroid spanning between a pair of bead portions 3. In the present invention, the carcass ply 4 is formed of textile cords having relatively high elasticity, and arranged in parallel with each other, and the number of the carcass plies can be at least one, and may be three or more. In addition, as depicted, both ends of the carcass ply 4 may each be folded back from the inside of the tire to the outside around the bead core 5 at the bead portion 3 to be thereby held, or may be sandwiched between the bead wires at both sides to be thereby held. Either fixing method may be used.

In the pneumatic tire 100 depicted, a two-layered belt layer 6 is arranged on the outside of the carcass ply 4 in the radius direction of the tire in the tread portion 1. In the present invention, the belt layer 6 can be arranged in the form of at least one layer, may be composed of two or more tilted belt layers arranged in such a manner that the direction of the cords in one layer crosses the direction of the cords in another, or may be a spiral belt composed of one or more rubber-coated cords wound spirally in the circumferential direction of the tire. In addition, examples of a reinforcing material constituting the belt layer 6 include a nylon fiber, aromatic polyamide (tradename: KEVLAR), steel, and the like. Among these, an aromatic polyamide and steel are reinforcing materials that do not stretch at high temperature, and can inhibit the expansion of the tread portion.

In addition, in the pneumatic tire 100 according to the present invention, a bead filler 7 can be arranged outside the bead core 5 in the radius direction of the tire, and an inner liner not depicted can be arranged as the innermost layer of the tire.

Furthermore, in the pneumatic tire 100 according to the present invention, the ratio of the height SWH of the maximum width position of the tire to the height SH of the cross section of the tire is preferably in the range of from 40% to 75%. Bringing the ratio SWH/SH within the range of from 40% to 75% in percentages makes it possible to afford a tire having a suitable ground contact surface and excellent steering stability, wherein SH is the height of the cross section of the tire, and SWH is the height of the maximum width position of the tire. Furthermore, in particular, in a case where a tire according to the present invention is a two-wheeled vehicle tire, the tire makes it possible to enhance the steering stability of the vehicle in a banked state during cornering. Here, the height SH of the cross section of the tire refers to ½ of a difference between the outer diameter of the tire and the diameter of a rim prescribed in the above-described industrial standard.

The pneumatic tire 100 according to the present invention can be used as any kind of tire as long as the tire is used as a driving wheel. The tire is suitably a two-wheeled vehicle tire or a three-wheeled vehicle tier, is particularly a motorcycle tire or a motor three-wheeled vehicle tire, and is used suitably as a rear tire for a motorcycle among others. In addition, the pneumatic tire 100 according to the present invention can be used as a tire having any one of a radial structure and a bias structure.

The pneumatic tire 100 according to the present invention has the above-described predetermined shape, has a tread pattern containing a plurality of width-direction grooves 11 and 12 extending across the tread center portion, has excellent water discharge efficiency on a paved road surface and also excellent traction performance, and thus, is useful particularly for an on-road motorcycle that runs mainly on a paved road surface.

### EXAMPLES

The present invention will now be described in more detail with reference to specific Examples.

### Example 1

A rear tire having a tire size of 170/60R17M/C for a motorcycle was produced, in which rear tire, a directional pattern containing a plurality of width-direction grooves as depicted in FIG. 1 was provided on the tread. In this sample tire, the plurality of width-direction grooves extended across the tread center portion, and had a convex pattern composed of one circular arc and protruded in the rotational direction of the tire. In addition, this sample tire satisfied the following conditions.
the number of width-direction grooves contained in the ground contact surface: 3
the average value Wg of the groove widths of the width-direction grooves, as measured on the tire equator: 9.0 mm
the ratio Lc/Wg of the average value Lc of the length of the center block in the circumferential direction of the tire, as measured on the tire equator, to the average value Wg of the above-described groove width: 460%
the ratio r/Dw of the radius of curvature, r, to the maximum groove depth Dw of the width-direction groove: 58%, wherein the radius of curvature was based on the boundary between the groove wall and the groove bottom on the leading side
the ratio Ds/Dc of the maximum groove depth Ds of the circumferential shoulder-portion groove to the maximum groove depth De of the circumferential center-portion groove: 0.4
negative ratio: 25.6%

The sample tire obtained was put on a rim having a size of MT 4.50×17 M/C, mounted on the rear tire of a 1200 cc motorcycle, and filled at an internal pressure of 290 kPa. The front tire used was a commercially available tire having a size of 120/70R19M/C.

### (Evaluation of Water Discharge Efficiency)

The above-described real motorcycle was ridden by a professional rider on a test course that had a paved road surface, and was sprinkled with water up to approximately 1 mm in depth. The water discharge efficiency was thus evaluated. The speed condition was as follows: entering a test course at approximately 40 km/h with the 3rd gear. The vehicle was operated so as to enter the straight course, and be then allowed to run with the accelerator full down until the speed of the vehicle reached 60 km/h or more on a GPS. The speed of the driving wheel was measured at the point of time when 60 km/h was reached. In this regard, the speed of the wheel was measured using a sensor attached to the vehicle body. When the speed of the vehicle was the same, the smaller the speed of the wheel was, less slippage was generated between the road surface and the tire, demonstrating that the water discharge efficiency was good.

### Comparative Example 1

The water discharge efficiency was evaluated in the same manner as in Example 1 except that the sample tire was mounted as a rear tire in such a manner that, in the directional pattern, the protruding direction of the convex pattern of the width-direction groove was the direction opposite to the rotational direction of the tire.

These results are shown in the following Table 1.

TABLE 1

| | | | Comparative |
|---|---|---|---|
| | | Example 1 | Example 1 |
| Protruding Direction of Convex Pattern | | Rotational | Direction Opposite |
| of Width-direction Groove | | Direction | to Rotational |
| | | of Tire | Direction of Tire |
| Speed of Wheel | Actual Measurement | 76.8 | 99.7 |
| when Speed of | (km/h) | | |
| Vehicle Has | Index (−), Assuming | 100 | 130 |
| Reached 60 km/h | that Value in | | |
| | Example is 100 | | |

As shown in the Table above, the results have verified that allowing the width-direction groove extending across the tread center portion to have a pattern convex in the rotational direction of the tire makes it possible to achieve good water discharge efficiency and to decrease the generation of slippage on a road surface having a water film.

### DESCRIPTION OF SYMBOLS

1: Tread Portion
2: Side-wall Portion
3: Bead Portion
4: Carcass Ply
5: Bead Core
6: Belt Layer
7: Bead Filler
11 and 12: Width-direction Groove
11B: Groove Bottom
11W: Groove Wall
21: Circumferential Center-portion Groove (Circumferential Groove)
22 and 23. Circumferential Shoulder-portion Groove (Circumferential Groove)
31: Center Block (Block)
32: Block
33: Shoulder Land Portion
100: Pneumatic Tire

1. A pneumatic tire for use as a driving wheel, comprising, on the tread of the tire, a directional pattern containing a plurality of width-direction grooves,
wherein, assuming that a half-width region of the tread, as measured from the tire equator to a tread-to-ground contact end along the surface of the tire in a cross section of the tread portion in the width direction of the tire, is bisected into two regions that are referred to as the tread center portion and the tread shoulder portion respectively in this order from the tire equator,
the plurality of width-direction grooves extend across the tread center portion and have a pattern convex in the rotational direction of the tire.

2. The pneumatic tire according to claim 1, wherein the ground contact surface comprises 2 to 6 of the width-direction grooves.

3. The pneumatic tire according to claim 1, wherein the average value Wg of the groove widths of the width-direction grooves, as measured on the tire equator, is 4 mm or more and 13 mm or less.

4. The pneumatic tire according to claim 1, wherein the ratio r/Dw of the radius of curvature, r, to the maximum groove depth Dw of the width-direction groove is 15% or more, wherein the radius of curvature is based on the boundary between the groove wall and the groove bottom on the leading side of the tire.

5. The pneumatic tire according to claim 1, wherein a plurality of circumferential grooves are provided to allow the plurality of width-direction grooves to be in communication with each other on the tread, and wherein, assuming that, among the plurality of circumferential grooves provided between a pair of the width-direction grooves, the circumferential groove the closest to the tire equator is referred to as a circumferential center-portion groove, and another circumferential groove is referred to as a circumferential shoulder-portion groove, the ratio Ds/Dc of the maximum groove depth Ds of the circumferential shoulder-portion groove to the maximum groove depth Dc of the circumferential center-portion groove satisfies 0.1 to 0.6.

6. The pneumatic tire according to claim 1, wherein a plurality of blocks are defined on the tread, and wherein the ratio Lc/Wg is 500% or less, assuming that Lc, as measured on the tire equator, is the average value of the lengths of center blocks located on the tire equator in the circumferential direction of the tire, the center blocks being among the plurality of blocks, and that Wg, as measured on the tire equator, is the average value of the groove widths of the width-direction grooves.

7. The pneumatic tire according to claim 1, wherein the convex pattern of the plurality of width-direction grooves is composed of one or two or more circular arcs.

8. The pneumatic tire according to claim 2, wherein the average value Wg of the groove widths of the width-direction grooves, as measured on the tire equator, is 4 mm or more and 13 mm or less.

9. The pneumatic tire according to claim 2, wherein the ratio r/Dw of the radius of curvature, r, to the maximum groove depth Dw of the width-direction groove is 15% or more, wherein the radius of curvature is based on the boundary between the groove wall and the groove bottom on the leading side of the tire.

10. The pneumatic tire according to claim 2, wherein a plurality of circumferential grooves are provided to allow the plurality of width-direction grooves to be in communication with each other on the tread, and wherein, assuming that, among the plurality of circumferential grooves provided between a pair of the width-direction grooves, the circumferential groove the closest to the tire equator is referred to as a circumferential center-portion groove, and another circumferential groove is referred to as a circumferential shoulder-portion groove, the ratio Ds/Dc of the maximum groove depth Ds of the circumferential shoulder-portion groove to the maximum groove depth Dc of the circumferential center-portion groove satisfies 0.1 to 0.6.

11. The pneumatic tire according to claim 2, wherein a plurality of blocks are defined on the tread, and wherein the ratio Lc/Wg is 500% or less, assuming that Lc, as measured on the tire equator, is the average value of the lengths of center blocks located on the tire equator in the circumferential direction of the tire, the center blocks being among the plurality of blocks, and that Wg, as measured on the tire equator, is the average value of the groove widths of the width-direction grooves.

12. The pneumatic tire according to claim 2, wherein the convex pattern of the plurality of width-direction grooves is composed of one or two or more circular arcs.

13. The pneumatic tire according to claim 3, wherein the ratio r/Dw of the radius of curvature, r, to the maximum groove depth Dw of the width-direction groove is 15% or more, wherein the radius of curvature is based on the boundary between the groove wall and the groove bottom on the leading side of the tire.

14. The pneumatic tire according to claim 3, wherein a plurality of circumferential grooves are provided to allow the plurality of width-direction grooves to be in communication with each other on the tread, and wherein, assuming that, among the plurality of circumferential grooves provided between a pair of the width-direction grooves, the circumferential groove the closest to the tire equator is referred to as a circumferential center-portion groove, and another circumferential groove is referred to as a circumferential shoulder-portion groove, the ratio Ds/Dc of the maximum groove depth Ds of the circumferential shoulder-portion groove to the maximum groove depth Dc of the circumferential center-portion groove satisfies 0.1 to 0.6.

15. The pneumatic tire according to claim 3, wherein a plurality of blocks are defined on the tread, and wherein the ratio Lc/Wg is 500% or less, assuming that Lc, as measured on the tire equator, is the average value of the lengths of center blocks located on the tire equator in the circumferential direction of the tire, the center blocks being among the plurality of blocks, and that Wg, as measured on the tire equator, is the average value of the groove widths of the width-direction grooves.

16. The pneumatic tire according to claim 3, wherein the convex pattern of the plurality of width-direction grooves is composed of one or two or more circular arcs.

17. The pneumatic tire according to claim 4, wherein a plurality of circumferential grooves are provided to allow the plurality of width-direction grooves to be in communication with each other on the tread, and wherein, assuming that, among the plurality of circumferential grooves provided between a pair of the width-direction grooves, the circumferential groove the closest to the tire equator is referred to as a circumferential center-portion groove, and another circumferential groove is referred to as a circumferential shoulder-portion groove, the ratio Ds/Dc of the maximum groove depth Ds of the circumferential shoulder-portion groove to the maximum groove depth Dc of the circumferential center-portion groove satisfies 0.1 to 0.6.

18. The pneumatic tire according to claim 4, wherein a plurality of blocks are defined on the tread, and wherein the ratio Lc/Wg is 500% or less, assuming that Lc, as measured on the tire equator, is the average value of the lengths of center blocks located on the tire equator in the circumferential direction of the tire, the center blocks being among the plurality of blocks, and that Wg, as measured on the tire equator, is the average value of the groove widths of the width-direction grooves.

19. The pneumatic tire according to claim 4, wherein the convex pattern of the plurality of width-direction grooves is composed of one or two or more circular arcs.

20. The pneumatic tire according to claim 5, wherein a plurality of blocks are defined on the tread, and wherein the ratio Lc/Wg is 500% or less, assuming that Lc, as measured on the tire equator, is the average value of the lengths of center blocks located on the tire equator in the circumferential direction of the tire, the center blocks being among the plurality of blocks, and that Wg, as measured on the tire equator, is the average value of the groove widths of the width-direction grooves.
